(19) United States
(12) Patent Application Publication
(10) Pub. No.: US 2011/0157018 A1
(43) Pub. Date: Jun. 30, 2011

(54) ELECTRONIC DEVICE

(76) Inventor: Tadashi Matsuda, Hamura-shi (JP)

(21) Appl. No.: 12/859,026

(22) Filed: Aug. 18, 2010

(30) Foreign Application Priority Data
Dec. 25, 2009 (JP) 2009-296135

(51) Int. Cl. G06F 3/033

(52) U.S. Cl. 345/160

(57) ABSTRACT

According to one embodiment, an electronic device includes: a casing; and an operating module exposed on an external surface of the casing at a nearer side than a keyboard in a depth direction of the casing, the operating module including a pointer operating module receiving an operation to move a pointer on a screen, a first click operating module receiving a click operation associated with a position of the pointer, and a second click operating module receiving a click operation associated with the position of the pointer, wherein among the pointer operating module, and the first and second click operating modules, the pointer operating module is t a nearest side in the depth direction, the first click operating module is at a farther side than the pointer operating module, and the second click operating module is at a farther side than the first click operating module in the depth direction.

### CROSS-REFERENCE TO RELATED APPLICATIONS

This application is based upon and claims the benefit of priority from Japanese Patent Application No. 2009-296135, filed Dec. 25, 2009, the entire contents of which are incorporated herein by reference.

### FIELD

Embodiments described herein relate generally an electronic device.

### BACKGROUND

Conventionally, a personal computer is known as an electronic device including, on a surface of its casing, a pointer operating module used to change a position of a pointer displayed on a display, and plural click operating modules used to perform click operation, as manual input operating modules.

Many conventional electronic devices have the click operating modules arranged at both sides of the pointer operating module. When the pointer operating module and the click operating modules in this arrangement are operated by a single hand, the pointer operating module is operated in many cases by the index finger due to the positioning of the thumb, the index finger, and the middle finger of the hand.

However, in this case, when the click operating module is also operated by the index finger, the index finger needs to be moved between the pointer operating module and the click operating modules, and a faster operation becomes difficult.

Meanwhile, if the click operating modules are operated by the thumb and the middle finger, the fingers used to operate the click operating modules are different from the index finger and the middle finger generally used to click a mouse. Therefore, a user accustomed to the mouse operation may find it difficult to operate the click operating module by the thumb.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an electronic device according to a first embodiment;

FIG. 2 is an exemplary plan view of a first main body of the electronic device in the embodiment;

FIG. 3 is an exemplary plan view of the first main body of the electronic device being operated by both hands (mainly by the right hand) of a user in the embodiment;

FIG. 4 is an exemplary side view of the first main body of the electronic device operated by the right hand in the embodiment;

FIG. 5 is an exemplary plan view of the first main body of the electronic device operated by the left hand in the embodiment;

FIG. 6 is an exemplary schematic block diagram of a part of a circuit configuration of an electronic device of the electronic device in the embodiment;

FIG. 7 is an exemplary plan view of a first main body of an electronic device according to a second embodiment;

FIG. 8 is an exemplary plan view of a first main body of an electronic device according to a third embodiment;

FIG. 9 is an exemplary plan view of a first main body of an electronic device according to a fourth embodiment; and

FIG. 10 is an exemplary plan view of a first main body of an electronic device according to a fifth embodiment.

### DETAILED DESCRIPTION

in general, according to one embodiment of the invention, an electronic device comprises a casing, a keyboard, and an operating module. The keyboard is arranged to be exposed on an external surface of the casing. The operating module is arranged to be exposed on the external surface of the casing at a nearer side than the keyboard in a depth direction of the casing. The operating module includes a pointer operating module configured to receive an operation to move a pointer on a screen, a first click operating module configured to receive a click operation associated with a position of the pointer, and one or plural second click operating modules configured to receive a click operation associated with the position of the pointer. Among the pointer operating module, the first click operating module, and the second click operating module, the pointer operating module is arranged at a nearest side in the depth direction. The first click operating module is arranged at a farther side than the pointer operating module in the depth direction, and the second click operating module is arranged at a farther side than the first click operating module in the depth direction.

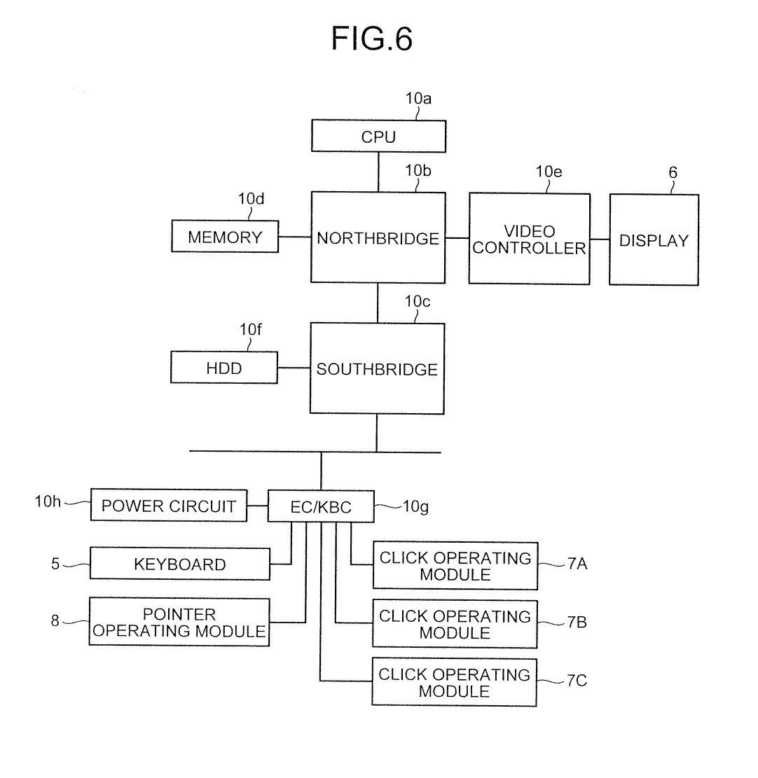

Exemplary embodiments are explained below in detail with reference to the accompanying drawings. The following embodiments comprise constituent elements similar to each other. Therefore, these identical constituent elements are denoted by common reference letters or numerals and redundant explanations thereof will be omitted. In the drawings except FIG. 6, directions are defined for the sake of explanation. That is, an X-direction and a Y-direction approximately follow a surface of a casing of a first main body. The X-direction indicates a width direction of the casing, and the Y-direction indicates a depth direction of the casing. A Z-direction is perpendicular to the surface of the casing of the first main body (thickness direction of the first main body). The X-direction, the Y-direction, and the Z-direction are orthogonal to each other.

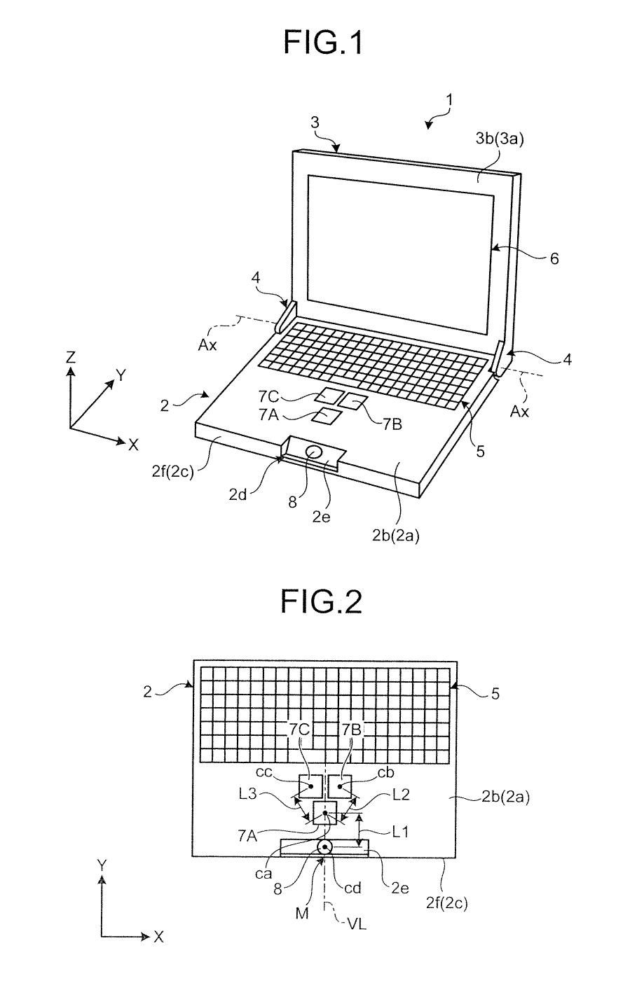

An electronic device according to a first embodiment is explained with reference to FIGS. 1 to 6.

As illustrated in FIG. 1, an electronic device 1 is configured as a so-called “notebook personal computer”, and includes a rectangular flat first main body 2, and a rectangular flat second main body 3. The first main body 2 and the second main body 3 are connected together by a hinge mechanism 4 relatively rotatably around a rotation axis Ax between an extended state illustrated in FIG. 1 and a folded state (not illustrated).

The first main body 2 includes a keyboard 5, click operating modules 7A to 7C, and a pointer operating module 8, as input operating modules to be exposed on a surface 2b as an external surface of a casing 2a. On the other hand, the second main body 3 includes a display 6 such as a liquid crystal display (LCD) to be exposed on a surface 3b as an external surface of a casing 3a. In the extended state, the keyboard 5, the click operating modules 7A to 7C, too pointer operating module 8, and the display 6 are exposed such that a user can use the electronic device 1. On the other hand, in the folded state, the surfaces 2b and 3b are opposite to each other in a mutually close state, and the keyboard 5, the click operating modules 7A to 7C, the pointer operating module 8, and the display 6 are hidden by the casings 2a and 3a. In the first embodiment, the click operating modules 7A to 7C and the pointer operating module 8 correspond to an operating module.

As illustrated in FIG. 2, the keyboard 5 has an approximately rectangular (a rectangle, in the first embodiment) region, wide in the width direction (the X-direction) and narrow in the depth direction (the Y-direction) of the first main body 2, respectively in a state that the user is using the electronic device 1. Accordingly, it can be said that the X-direction is a longitudinal direction of an installation region of the keyboard 5, and the Y-direction is a short-side direction of the installation region of the keyboard 5. Further, it can be said that the X-direction approximately follows the surface 2b and follows an edge 2f. The Y-direction approximately follows the surface 2b and is perpendicular to the edge 2f.

The pointer operating module 8 is the input operating module that receives an operation to move a position displayed by a pointer indicated by an arrowhead or the like on a screen of the display 6. The pointer operating module 8 is configured as a trackball in the first embodiment. In the first embodiment, as illustrated in FIG. 1, a notched recess 2d is formed at an upper part of a center of the longitudinal direction (the X-direction) of a sidewall 2c of the casing 2a (that is, a corner at the surface 2b side). As illustrated also in FIG. 4, at a far side of the recess 2d, an inclined surface 2e is formed whose normal direction P is directed to an obliquely upward direction (a direction between a near side of the user in the depth direction and an upward direction). The pointer operating module 8 is arranged to be exposed on toe inclined surface 2e. As illustrated in FIGS. 2 and 4, in the extended state (a used state), the pointer operating module 8 is also exposed to an upper side of the surface 2b. Because the pointer operating module 8 is accommodated in the recess 2d, the pointer operating module 8 does not interfere with the second main body 3 even when the electronic device 1 is in the folded state.

Each of the click operating modules 7A to 7C is an input operating module that receives a click operation associated with a position of the pointer on the screen as an input, and is configured as a push button in the first embodiment. As illustrated in FIG. 2, in a plan view, the click operating modules 7A to 7C are arranged between the pointer operating module 8 and the keyboard 5.

The click operating module 7A is arranged at a farther side than the pointer operating module 8 in the depth direction (the Y-direction), that is, at a farther side from the edge 2f of the near side than the pointer operating module 8 in the depth direction (the Y-direction).

The click operating modules 7B and 7C are arranged between the click operating module 7A and the keyboard 5, at a farther side than the click operating module 7A in the depth direction (the Y-direction), that is, at a farther side from the edge 2f of the near side than the click operating module 7A in the depth direction (the Y-direction). That is, in the first embodiment, the click operating module 7A corresponds to a first click operating module, and the click operating modules 7B and 7C correspond to second click operating modules.

The pointer operating module 8 and the click operating module 7A are, in a plan view, arranged following a virtual line segment VL following a direction (the Y-direction) perpendicular to the edge 2f passing an intermediate point (an intermediate point in the longitudinal direction the X-direction)) M of the edge 2f. That is, the pointer operating module 8 and the click operating module 7A are aligned in the depth direction (the Y-direction). The virtual line segment VL is a center line of an arrangement of the pointer operating module 8 and the click operating module 7A. That is, in a plan view illustrated in FIG. 2 (a view from the normal direction of an average plane of the surface 2b), both a center cd of the pointer operating module 8 and a center ca of the click operating module 7A are arranged on the virtual line segment VL.

In a plan view, the click operating modules 7B and 7C are arranged line symmetrically with the virtual line segment VL s the center line of the arrangement of the pointer operating module 8 and the click operating module 7A. That is, the click operating modules 7B and 7C are aligned along the width direction (the X-direction), and are arranged at a position deviated from the position of the click operating module 7A in the direction along the edge 2f (the width direction, the X-direction). However, a deviation direction of the click operating module 7B from the click operating module 7A and a deviation direction of the click operating module 7C from the click operating module 7A are different from each other. In the first embodiment, these directions are opposite to each other. The click operating module 7B is arranged at a position deviated in one direction (a right side in FIG. 2) of the X-direction from the position of the click operating module 7A, and the click operating module 7C is arranged at a position deviated in the other direction (a left side in FIG. 2) of the X-direction from the position of the click operating module 7A.

In the first embodiment, a distance L1 between the center cd of the pointer operating module 8 and the center ca of the click operating module 7A is longer than a distance L2 between the center ca of the click operating module 7A and a center cb of the click operating module 7B, and is longer than a distance L3 between the center ca of the click operating module 7A and a center cc of the click operating module 7C (L1>L2, L1>L3). The distance L2 between the center ca of the click operating module 7A and the center cc of the click operating module 7B is the same as the distance L3 between the center ca of the click operating module 7A and the center cc of the click operating module 7C (L2=L3).

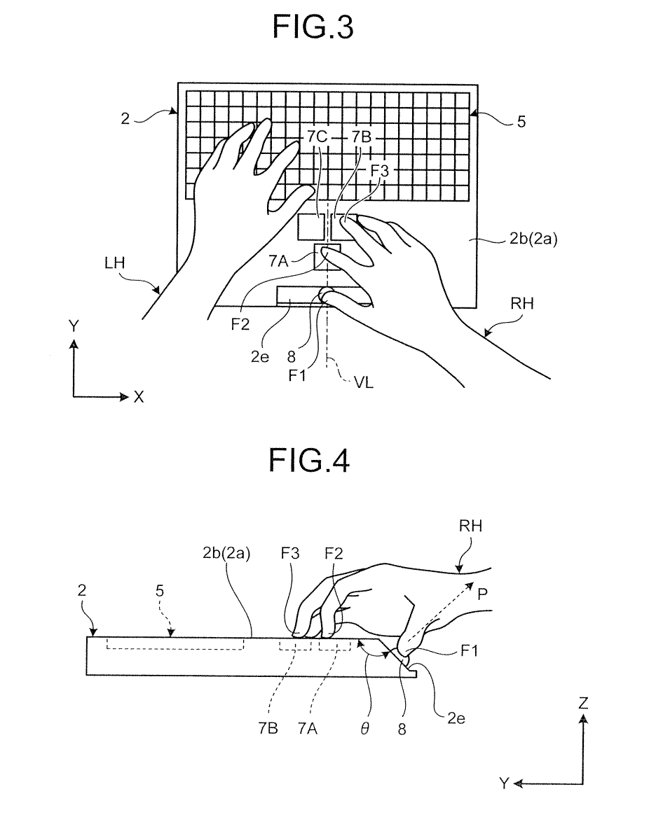

Based on the arrangement of the pointer operating module 8 and the click operating modules 7A and 7B described above, as illustrated in FIG. 3, the pointer operating module 8 can be operated by a thumb F1 of a right hand RH of a user, the click operating module 7A can be operated by an index finger F2 of the right-hand RH, and the click operating module 7B can be operated by a middle finger F3 of the right hand RH. It can be easily understood from FIG. 3 that the pointer operating module 8 and the click operating modules 7A and 7B can be easily operated by the thumb F1, the index finger F2, and the middle finger F3 of the right hand RH, respectively, in a posture that a front arm of the right hand RH is stretched in inclination from a right side of the width direction and also from the near side in the depth direction toward a left side of the width direction and also toward a far side in the depth direction.

Further, as illustrated in FIG. 4, in the first embodiment, the normal direction P of the inclined surface 2e as the external surface of the casing 2a on which the pointer operating module 8 is arranged is directed to between the near side in the depth direction and an upside, and a normal direction of the surface 2b as the external surface of the casing 2a is directed upward (the Z-direction). The surface 2b and the inclined surface 2e are crossed at an obtuse angle θ (135°, for example). When the right hand RH is placed on the surface 2b of the casing 2a, the thumb F1 can be easily moved toward an inclined lower direction on a center side and a lower side of the palm, due to the structure of the hand. Therefore, it is assumed that the pointer operating module 8 is operated by the thumb F1, the click operating module 7A is operated by the index finger F2, and the click operating module 7B is operated by the middle finger, preferably, the normal direction of the surface 2b as an installation surface of the click operating modules 7A to 7C is directed upward and the normal direction P of the inclined surface 2e as an installation surface of the pointer operating module 8 is directed obliquely upward between the near side in the depth direction and an upside. With this arrangement, the inclined surface 2e and the ball of the thumb F1 can be set closer to parallel, and the operability of the pointer operating module 8 can be increased. This configuration is also applicable to a left hand LH as well.

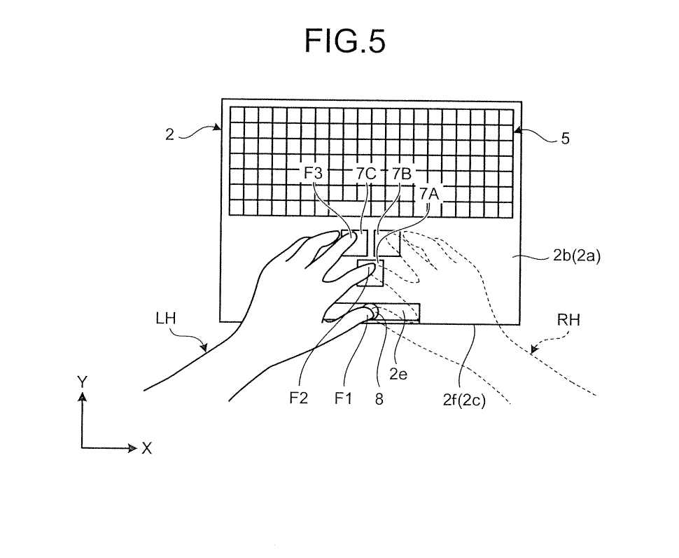

As illustrated in FIG. 5, an arrangement of the pointer operating module 8 and the click operating modules 7A and 7C is suitable for an operation of these modules by the left hand LH. That is, the pointer operating module 8 can be operated by the thumb F1 of the left hand LH, the click operating module 7A can be operated by the index finger F2 of the left hand LH, and the click operating module 7C can be operated by the middle finger F3 of the left hand LH. It can be easily understood from FIG. 5 that the pointer operating module 8 and the click operating modules 7A and 7C can be easily operated by the thumb F1, the index finger F2, and the middle finger F3 of the left hand LH, respectively, in a posture that a front arm of the left hand LH is stretched in inclination from a left side of the width direction and also from the near side in the depth direction toward a right side of the width direction and also toward a far side in the depth direction.

That is, as is clear from FIGS. 3 and 5, the arrangement of the pointer operating module 8 and the click operating modules 7A to 72 according to the first embodiment can increase the operability by the thumb F1, the index finger F2, and the middle finger F3 of the right hand RH and of the left hand LH, respectively.

As illustrated in FIG. 6, the electronic device 1 according to the first embodiment includes a central processing unit (CPU) 10a, a northbridge 10b, a southbridge 10c, a memory 10d, a video controller 10e, a hard disk drive (HDD) 10f, an embedded controller/keyboard controller (EC/KBC) 10g, and a power circuit 10h. These modules are connected to each order via a bus or the like. FIG. 6 exemplifies a part of a circuit configuration.

The CPU 10a controls the entire system. The HDD 10f stores various data, an operating system (OS), various application programs operated in the OS, and driver programs. When a power source is turned on, the OS is loaded on the memory 10d, and is started. The application programs and the driver programs are also loaded on the memory 10d, and can be executed by the CPU 10a.

The video controller 10e controls a display of a screen of the display 6. The video controller 10e controls a display of a pointer (not illustrated) on the screen of the display 6.

The EC/KBC 10g is a microcomputer with which an embedded controller that controls the power circuit 10h, and a controller (a keyboard controller) that controls the keyboard 5, the click operating modules 7A to 7C, and the pointer operating module 8 and so on are integrated. In the EC/KBC 10g, operation signals corresponding to operations of the keyboard 5, the pointer operating module 8, and the click operating modules 7A to 7C are generated to be transmitted to the CPU 10a. These operation signals are processed by the driver programs and the application programs operated by the CPU 10a, for example. The operation signals corresponding to the operations of the click operating modules 7A to 7C can be variably set by operations of the CPU 10a and the EC/KBC 10g following the driver programs and the application programs, for example. A user who operates the pointer operating module 8 and the click operating modules 7A and 7B by mainly the right hand RH can set by the programs the click operating module 7C to a certain function switch to use the click operating module 7C as a shift key and a certain function key, for example. Similarly, a user who operates the pointer operating module 8 and the click operating modules 7A and 7C by mainly the left hand LH can set by the programs the click operating module 7B to a certain function switch to use the click operating module 7B as shift key and a certain function key.

As explained above, in the first embodiment, the click operating module 7A as the first click operating module is arranged at a farther side from the edge 2f than the pointer operating module 8. The click operating modules 7B and 7C as the second click operating modules are arranged at a farther side from the edge 2f than the click operating module 7A as the first click operating module. Therefore, becomes easy to operate the pointer operating module 8 by the thumb F1, operate the click operating module 7A by the index finger F2, and operate the click operating modules 7B and 7C by the middle finger F3. That is, it becomes easy to operate the pointer operating module 8 and the click operating modules 7A to 7C by one hand, and the click operating modules 7B and 7C can be operated by the same finger as that used to handle the mouse.

In the first embodiment, the distance L1 between the center cd of the pointer operating module 8 and the center ca of the click operating module 7A is longer than the distance L2 between the center cb of the click operating module 7B and the center ca of the click operating module 7A, and is also longer than the distance L3 between the center cc of the click operating module 7C and the center ca of the click operating module 7A. Due to the structure of the hand, when the right hand RH or the left hand LH is put on the surface 2b of the casing 2a, a distance between a tip of the thumb F1 and a tip of the index finger F2 is longer in many cases than a distance between the tip of the index finger F2 and a tip of the middle finger F3. Therefore, it becomes easier to use these modules in this arrangement.

In the first embodiment, the click operating modules 7B and 7C are arranged at a position deviated from an arrangement of the pointer operating module 8 and the click operating module 7A (including the virtual line segment VL and an extended line passing the centers cd and ca). Due to the structure of the hand, when the right hand RH or the left hand LH is put on the surface 2b of the casing 2a, in a plan view, in many cases, a tip of the middle finger F3 is deviated sideway from a line connecting between a tip of the thumb F1 and a tip of the index finger F2 and its extension line. Therefore, it becomes easier to use these modules in this arrangement.

In the first embodiment, the arrangement of the pointer operating module 8 and the click operating module 7A (the virtual line segment VL) follows the Y-direction (the depth direction, the direction perpendicular to the edge 2f). Therefore, two click operating modules 7B and 7C as the second click operating modules can be arranged at both sides in the width direction sandwiching the arrangement (the virtual line segment VL) (the X-direction, left and right directions for a user). Consequently, the pointer operating module 8 and the click operating modules 7A to 7C can be easily used by both the right hand RH and the left hand LH. Particularly, this arrangement is suitable for postures of the forearms of both the right hand RH and the left hand LH.

In the first embodiment, plural click operating modules 7B and 7C are provided as the second click operating modules. Therefore, the pointer operating module 8 and the click operating modules 7A to 7C can be easily used by both the right hand RH and the left hand LH. Any of the click operating modules 7B and 7C can be used as the function switch.

In the first embodiment, the plural click operating modules 7B and 7C are provided as the second click operating modules of which directions deviated from an arrangement (the virtual line segment VL) are different. Therefore, the pointer operating module 8 and the click operating modules 7A to 7C can be easily used by both the right hand RH and the left hand LH.

In the first embodiment, the pointer operating module 8 and the click operating modules 7A to 7C are arranged to be exposed above the surface 2b as the external surface. Therefore, the pointer operating module 8 and the click operating modules 7A to 7C can be more easily operated by the right hand RH or the left hand LH arranged on the surface 2b of the casing 2a.

In the first embodiment, the click operating modules 7A to 7C are arranged on the surface 2b as the external surface of which normal direction is directed upward, and the pointer operating module 8 is arranged on the inclined surface 2e as the external surface of which normal direction P is directed to the near side in the depth direction. Accordingly, the surface 2b and the inclined surface 2e are formed and the pointer operating module 8 and the click operating modules 7A to 7C are arranged at more suitable positions for each of the thumb F1, the index finger F2, and the middle finger F3 of which easily movable positions are different according to the structure of hands. Therefore, the ease of using these modules can be more improved.

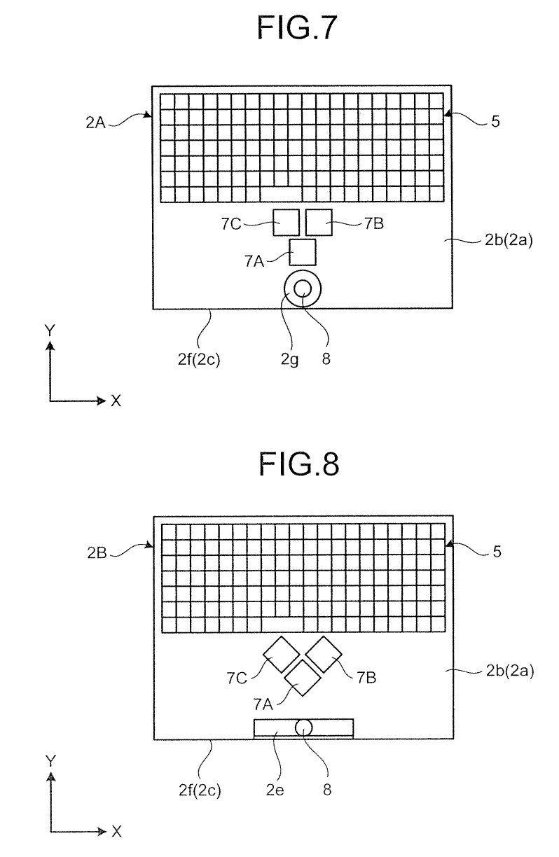

As illustrated in FIG. 7, in the first main body 2A according to a second embodiment, the click operating modules 7A to 7C are also arranged on the surface 2b of the casing 2a in a similar manner to that in the first embodiment. On the other hand, a circular recess 2g in a plan view is formed between the click operating modules 7A to 7C and the edge 2f to be located at a user's side in a used state, on the surface 2b of the casing 2a. The pointer operating module 8 is arranged on a bottom of the recess 2g. The pointer operating module 8 is exposed above the surface 2b of the casing 2a as well as the click operating modules 7A to 7C.

The positional relationship between the pointer operating module 8 and the click operating modules 7A to 7C in a plan view is similar to that in the first embodiment although a configuration of a portion on which the pointer operating module 8 is set is different from that in the first embodiment. Therefore, the second embodiment can also achieve effects identical those of the first embodiment.

As illustrated in FIG. 8, in the first main body 2B according to a third embodiment, a posture of the click operating modules 7A to 7C in a plan view is different from that in the first embodiment. That is, the click operating modules 7A to 7C are rotated by 45° on the surface 2b from those in the first embodiment. Therefore, the click operating modules 7A to 7C can be arranged in a V shape. Consequently, the pointer operating module 8 and the click operating modules 7A to 7C can be used easily by both the right hand RH and the left hand LH, and the appearance of the device cart be improved. According to the third embodiment, it is easy that the rectangular click operating modules 7A to 7C are arranged closer to each other, and each of the click operating modules 7A to 7C are formed in a larger shape.

The positional relationship between the pointer operating module 8 and the click operating modules 7A to 7C in a plan view is similar to that in the first embodiment although the posture (shape) of the click operating module 7A is different from that in the first embodiment. Therefore, the third embodiment can also achieve effects identical those of the first embodiment.

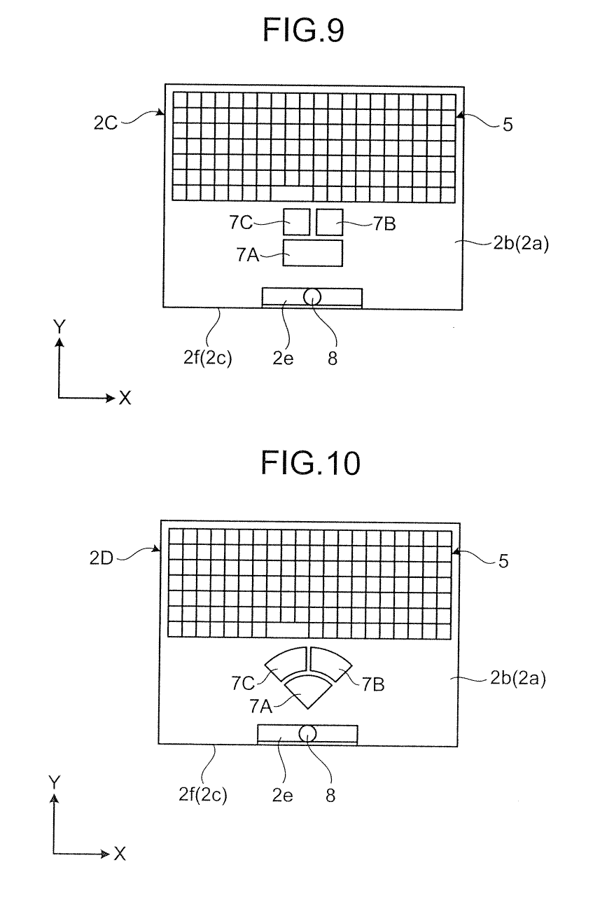

As illustrated in FIG. 9, in the first main body 2C according to a fourth embodiment, the click operating module 7A is longer than that in the first embodiment in the X-direction, and is formed in a rectangle. By an enlarged portion of the click operating module 7A, positioning flexibility of the finger (the index finger F2) on the click operating module 7A is increased, and it becomes easier to operate the click operating module 7A.

The positional relationship between the pointer operating module 8 and the click operating modules 7A to 7C in a plan view is similar to that in the first embodiment, although the shape of the click operating module 7A is different from that in the first embodiment. Therefore, the fourth embodiment can also achieve effects identical those of the first embodiment.

As illustrated in FIG. 10, in the first main body 2D according to a fifth embodiment, the click operating module 7A is formed fan-shaped. A constant width is formed between the click operating modules 7B and 7C, which are formed in an arc shape bent along an external diameter of the click operating module 7A. The positional relationship between the pointer operating module 8 and the click operating modules 7A to 7C in a plan view is similar to that in the first embodiment although shapes of the click operating modules 7A to 7C are different from that in the first embodiment. Therefore, the fifth embodiment can also achieve effects identical those of the first embodiment.

For example, the embodiments described above can be carried out as an electronic device other than the notebook personal computer. Further, the pointer operating module can be configured as other pointing devices such as touch pad or a pointing stick. In addition, the specifications (such as its structure, number, shape, and size) of the click operating module can be appropriately changed.

According to the above embodiments, it is easy to operate the pointer operating module by the thumb and to operate first and second click operating modules by the index finger and the middle finger.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a casing;
a keyboard arranged to be exposed on an external surface of the casing; and
an operating module arranged to be exposed on the external surface of the casing at a nearer side than the keyboard in a depth direction of toe casing, the operating module including a pointer operating module configured to receive an operation to move a pointer on a screen, a first click operating module configured to receive a click operation associated with a position of the pointer, and one or plural second click operating modules configured to receive a click operation associated with the position of the pointer, wherein
among the pointer operating module, the first click operating module, and the second click operating module, the pointer operating module is arranged at a nearest side in the depth direction,
the first click operating module is arranged at a farther side than the pointer operating module in the depth direction, and
the second click operating module is arranged at a farther side than the first click operating module in the depth direction.

2. The electronic device of claim 1, wherein a distance between a center of the pointer operating module and a center of the first click operating module is longer than a distance between the center of the first click operating module and a center of the second click operating module.

3. The electronic device of claim 1, wherein the second click operating module is arranged at a position deviated from an arrangement of the pointer operating module and the first click operating module.

4. The electronic device of claim 3, wherein one of the second click operating modules is arranged at the position deviated toward one side of the arrangement, and the other one of the second click operating modules is arranged at the position deviated toward the other side of the arrangement.

5. The electronic device of claim 4, wherein the first click operating module and two of the second click operating modules are arranged in a V shape.

6. The electronic device of claim 1, wherein the pointer operating module and the first and second click operating modules are arranged to exposed above the external surface.

7. The electronic device of claim 1, wherein
the first and second click operating modules are arranged on the external surface whose normal direction is directed upward, and
the pointer operating module is arranged on the external surface whose normal direction is directed to a near side in the depth direction.

8. An electronic device comprising:
a casing; and
an operating module including a pointer operating module arranged on an external surface of the casing, a first click operating module arranged on the external surface of the casing, and a second click operating module arranged on the external surface of the casing, the first click operating module being arranged at the position sandwiched between the pointer operating module and the second click operating module.

9. An electronic device comprising:
a casing; and
an operating module including two click operating modules arranged on an external surface whose normal direction is directed upward of the casing, and a pointer operating module arranged on the external surface whose normal direction is directed to a near side in a depth direction of the casing at a position, the pointer operating module being closer to an edge at a near side in the depth direction of the casing than the click operating module.
